(19) United States
(12) Patent Application Publication
(10) Pub. No.: US 2016/0174458 A1
(43) Pub. Date: Jun. 23, 2016

(54) Vegetable seed planter

(71) Applicant: Gary Thacker, Tucson, AZ (US)

(72) Inventor: Gary Thacker, Tucson, AZ (US)

(21) Appl. No.: 14/544,282

(22) Filed: Dec. 18, 2014

(51) Int. Cl. A01C 7/12

(52) U.S. Cl. CPC A01C 7/128

(57) ABSTRACT

A planter that ejects seeds rearward at a speed that is equal to or nearly equal to the forward motion of the machine. This prevents the seeds from bouncing and rolling on the soil and maintains the desired spacing between seeds. This is accomplished with a wheel having cells that accept a single seeds and a belt that holds the seeds in the cells while the wheel rotates down close to the soil, where the seeds are released at a rearward velocity that compensates for the forward motion of the machine.

Priority for this invention is claimed from U.S. Provisional Patent application Ser. No. 61/964,204, entitled “Vegetable Seed Planter”, filed on Dec. 27, 2013.

### BACKGROUND OF THE INVENTION

This invention relates to planters and more particularly to vegetable planters, where uniform placement of seeds is highly desired.

Uniform spacing of vegetable seeds and seedlings is essential for the proper growth and maturation of vegetables such as iceberg lettuce, cabbage, cauliflower, melons, and a host of other crops. The optimum plant spacing for iceberg lettuce is ten inches apart in the seed row. To ensure full stands of plants, growers typically plant the seeds at about 2 inches apart. After germination of the seeds, the extra seedlings are removed by hand hoeing (thinning) to achieve the desired plant spacing. Thinning machines are now being introduced to reduce the labor requirements.

The vegetable planters currently in use do a very good job of selecting and ejecting only one seed at a time, however when the seeds drop to the soil they may bounce and roll due to the forward motion of the machine. This introduces a significant error factor into the uniformity of the seed spacing. This is especially problematic when two seeds come to rest next to each other and the resulting two adjoining plants are called a “double”. Hand thinning crews can carefully remove only one seedling of a double but it is tedious and it slows them down. The new thinning machines are unable to deal with doubles.

The current vegetable seed planters must be operated at very low speeds (2 MPH or less) to maintain good seed spacing. This reduces the machine productivity and increases the per acre cost of the planter, tractor and driver. The slow speed makes it very difficult if not impossible for growers to maintain their planting schedule, which is essential to having the fields come to harvest at the desired times.

It is clear that there is a significant need to create a vegetable planter that will achieve the desired seed spacing at 3-5 MPH machine speeds.

### SUMMARY OF THE INVENTION

In the present invention, a seed planter mechanism draws the seed from a hopper containing the seeds o be planted. In the preferred embodiment of the invention, the seeds are peletized for ease of planting and to assist in germination.

The use of hoppers and seed dispersal therefrom is well known in the art and include, but not limited to, that described in U.S. Pat. No. 6,681,706, entitled “Apparatus and Method for Controlled Delivery of Seeds to an Open Furrow” issued to Sauder et al. on Jan. 27, 2004; incorporated hereinto by reference.

The seeds are withdrawn from the hopper using a rotating seed wheel. On a peripheral surface the rotating seed wheel has recessed cells configured to accept a single seed as the cells rotated through the hopper

The creation of cells to pick individual seeds is well known to those of ordinary skill in the art and include, but not limited to, the technique described in U.S. Pat. No. 5,027,725, entitled “Seed Dispenser for Planters” issued to Keeton on Jul. 2, 1991; and, U.S. Pat. No. 4,924,786, entitled “Seed Dispenser with Dual-Faced Seed Plate” issued to Keeton on May 15, 1990; both of which are incorporated hereinto by reference.

To maintain the seeds within the cells until the proper time for dispersal, a belt, moving at a speed substantially equal to a speed of the peripheral surface of the rotating seed wheel, covers the cell. The belt engages the peripheral surface of said rotating seed wheel after the rotating seed wheel exits from the hopper and lays over the cell in a substantially fixed relationship to keep the seed within the cell.

This covering of the cell is maintained until the cell approaches or is proximate to a lowermost position of said rotating seed wheel. When the belt moves away from the peripheral surface, the seed is then freed to be flung from the cell due to gravity and the natural centrifugal force created by the movement of the rotating seed wheel.

In the preferred embodiment, the belt is maintained in a proper register against the peripheral surface either by walls next to the rotating seed wheel or through the use of ridges on the peripheral surface. The belt is configured to nest between these two ridges.

As the cell is released from the confines of the belt, the seed is flung in an opposite direction from a direction of movement of the seed planter mechanism. This rearward motion is ideally equal to the forward motion of the seed planter mechanism so that the seed “falls” onto the agricultural field without “skipping”.

To match the rotation of the rotating seed wheel to the forward motion a variety of drive mechanisms are usable. One such mechanism mechanically connects a ground engaging wheel to an axle extending through the rotating seed wheel.

Ideally, the drive mechanism communicates a rotation of the ground engaging wheel to the axle of the rotating seed wheel so that the speed of the peripheral surface approximates a horizontal speed of the rotating seed wheel across the agricultural field.

Those of ordinary skill in the art readily recognize a variety of mechanisms which can be used in this context to provide a driving mechanism for the planter, including, but not limited to: U.S. Pat. No. 7,343,868, entitled “Seed Placement System for use in a Seeding Mechanism” issued to Stephens et al. on Mar. 18, 2008; and, U.S. Pat. No. 6,729,249, entitled “Seed Belt Housing with Impact Absorbing Material to Reduce Seed Skip and Method for Same” issued to Sauder et al. on May 4, 2004; all of which are incorporated hereinto by reference.

Ideally, the distance that the rotating seed wheel is from the agricultural field is controlled by adjustable leading and a following gauge wheel. The leading and following gauge wheels are set for the specific application desired. Those of ordinary skill in the art readily recognize a variety of such structures, including, but not limited to those described in U.S. Pat. No. 6,477,967 entitled “Seed Planter” issued to Rosenboom on Nov. 12, 2002; incorporated hereinto by reference.

In the preferred embodiment, the following gauge wheel presses the flung seed lying on the ground surface, so that the seed is implanted below the ground surface.

To prevent seeds from clogging a cell, a clean out groove extends the entirety of the circumference of the peripheral surface of the rotating seed wheel through each of the cells. A fixed blade rides in the clean out groove at a position after the point where the seed is designed to be flung from the cell.

Another attribute of the present invention's preferred embodiment is a sealing mechanism adapted to prevent seeds from escaping from the hopper except as carried by the cells in the rotating seed wheel. This sealing is accomplished through a variety of mechanisms such as a brush or a rotating wheel rotating opposite the direction of the rotational direction of the rotating seed wheel so that the seeds are maintained in the hopper.

In more detail, in the preferred embodiment, a gang of planters are pulled through the agricultural field to increase the efficiency of the planting operation.

Those of ordinary skill in the art readily recognize a variety of techniques which can create such a gang arrangement, including, but not limited to: U.S. Pat. No. 8,468,960, entitled “Seeding Machine with Seed Delivery System” issued to Gamer et al. on Jun. 25, 2013; incorporated hereinto by reference.

The present invention selects one seed at a time with a vertical wheel with cells to accept only one seed at a time. Seeds are drawn from a reservoir by falling into the cells of the seed wheel. The seed wheel rotates at a speed that is equal to or nearly equal to the forward motion of the machine. A repeller wheel sweeps all extra seeds back into the reservoir. With only one seed per cell in the seed wheel, a belt comes into contact with the seed wheel, holding the seeds in the cells as the wheel rotates down to the soil. Near the soil, the belt rolls around an idler wheel, releasing the seed near the soil and at a rearward speed that compensates for the forward motion of the machine. An opener shoe forms a small V-shaped trench in the soil for the seed to fall into. An optional press wheel will push the seed into the soil at a desired depth.

The invention, together with various embodiments thereof, will be more fully explained by the accompanying drawings and the following description thereof.

### DRAWINGS IN BRIEF

FIG. 1 shows the preferred embodiment of the invention in a cross-sectional view

FIG. 2 illustrates a part of the seed wheel in a perspective and cross sectional view.

FIGS. 3A and 3B illustrate an embodiment of the invention's nesting attribute of the belt to the rotating seed wheel.

FIGS. 4A and 4B illustrate the preferred embodiment of the invention's nesting attribute of the belt to the rotating seed wheel.

FIG. 5 illustrates a top view of the embodiment of the invention utilizing a gang of planters being pulled by an agricultural vehicle.

FIG. 6 illustrates a chain driven embodiment of the invention used to coordinate the rotation of the rotating seed wheel to traveling over the agricultural field.

### DRAWING IN DETAIL

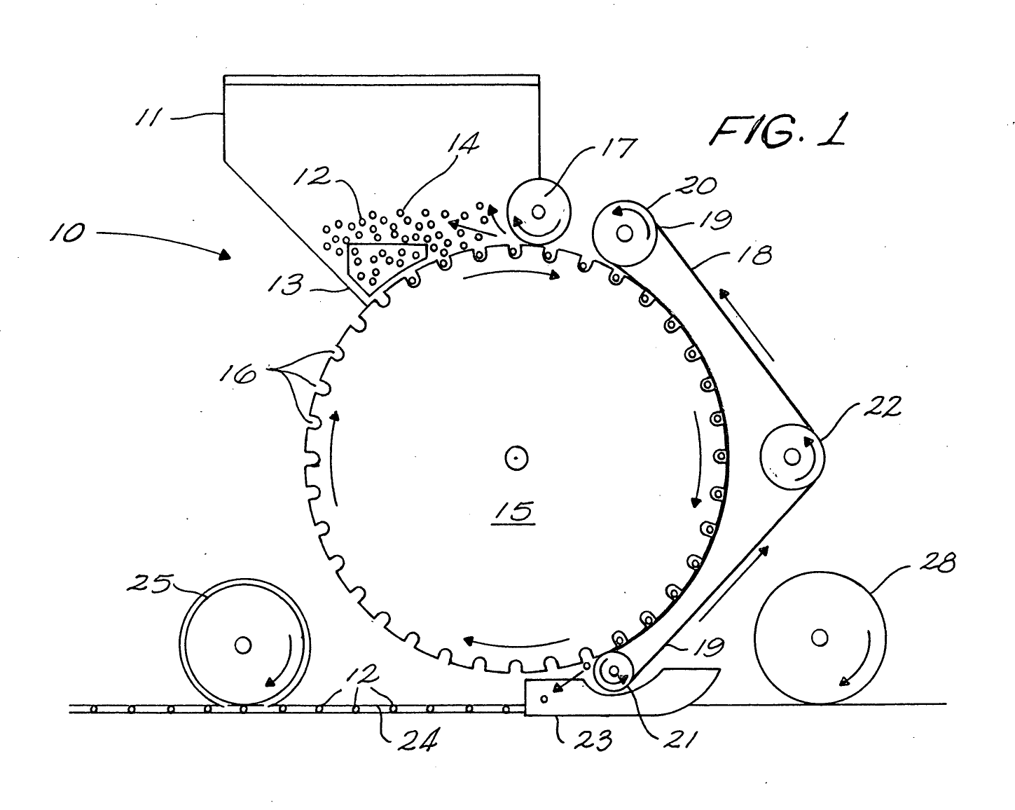

FIG. 1 shows the preferred embodiment of the invention in a cross-sectional view.

The planter unit is general indicated by the numeral 10. Seed hopper 11 holds most of the seeds 12 before they migrate through choke point 13 and into seed reservoir 14. At the bottom of seed reservoir 14, vertically oriented seed wheel 15, with seed cells 16, rotates forward. Seeds 12 fall into seed cells 16 as seed wheel 15 rotates. Repeller wheel 17 sweeps all extra seeds back into seed reservoir 14. Guide block 18 holds seeds 12 in seed cells 16 for a short distance.

With seeds 12 singularly seated in seed cells 16, belt 19 rotates around top idler 20 and comes into contact with seed wheel 15, holding the seeds in seed cells 16 as seed wheel 15 rotates down toward the soil. Near the soil surface, belt 19 rotates around lower idler 21, releasing seeds 12 from seed cells 16. Belt 19 continues its rotation back upward, around spring-loaded idler 22 and top idler 20 to repeat its cycle. Ideally, the speed of belt 19 approximates the speed of cells 16 to minimize any abrasion the seeds within cells 16 may experience.

Seeds 12 are ejected with a rearward velocity that compensates for the forward motion of the machine. Opener 23 makes a V-shaped groove in soil 24 for seeds 12 to fall into. Seeds 12 come into contact with groove in soil 24 at a zero or nearly zero velocity and come to rest without bouncing or rolling.

After seeds 16 are released, clean-out blade 25 is positioned in clean-out groove 26 (shown in dotted form) to keep anything from clogging cells 16. Seed wheel 15 rotates back up to seed reservoir 14 to repeat the cycle.

The operating height of the invention may or may not be controlled by front gauge wheel 27 and/or rear gauge wheel 28. Rear gauge wheel 28 may have an optional shape or profile to press seeds 12 into the soil at a desired depth.

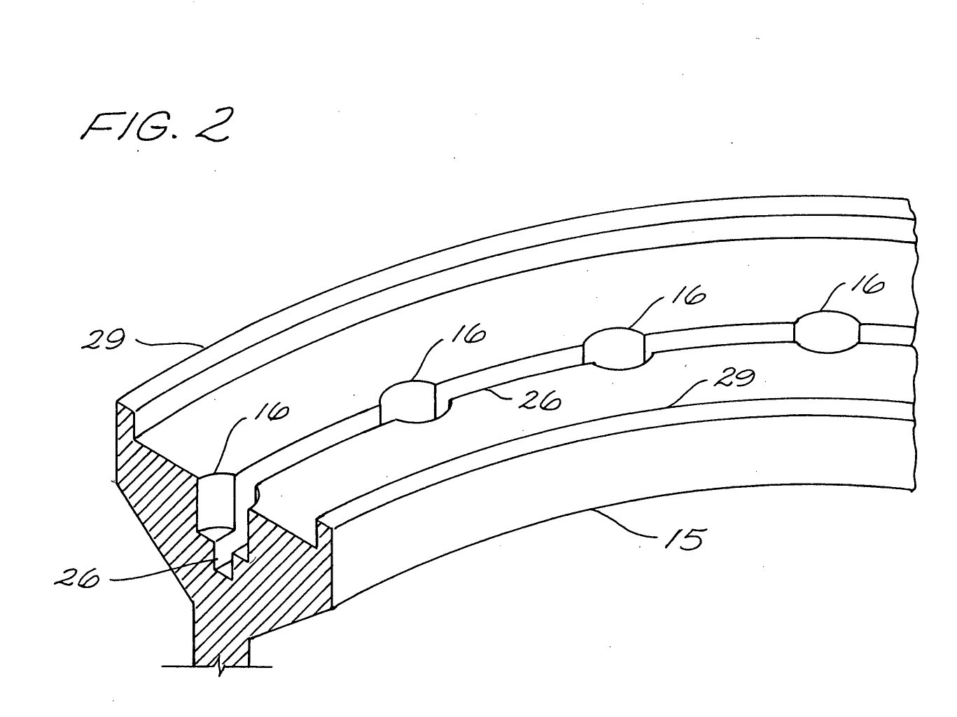

FIG. 2 illustrates a part of the seed wheel in a perspective and cross sectional view.

Part of seed wheel 15 is shown in a perspective and cross sectional view. Clean-out groove 26 is shown bisecting seed cells 16 and is deeper than seed cells 16. This allows clean-out blade 25 to reach deeper than the seed cells 16 to eject any stuck seeds or debris from seed cells 16.

Ideally seed wheel 15 to has raised edges 29 to keep belt 19 aligned on seed wheel 15.

FIGS. 3A and 3B illustrate an embodiment of the invention's nesting attribute of the belt to the rotating seed wheel. FIG. 3A illustrates a frontal view; FIG. 3B is a top/side view of the rotating seed wheel with the belt engaged thereto.

In this embodiment, rotating seed wheel 31 is contained between side walls 30A and 30B. Cells 32 are adapted to contain a seed (not shown). After the seeds have been placed within cells 32, belt 33 contacts the peripheral surface 34 and rides thereon. Belt 33 ideally moves at the same speed as the peripheral surface 34 so as to eliminate any abrasion the seed may experience with belt 33.

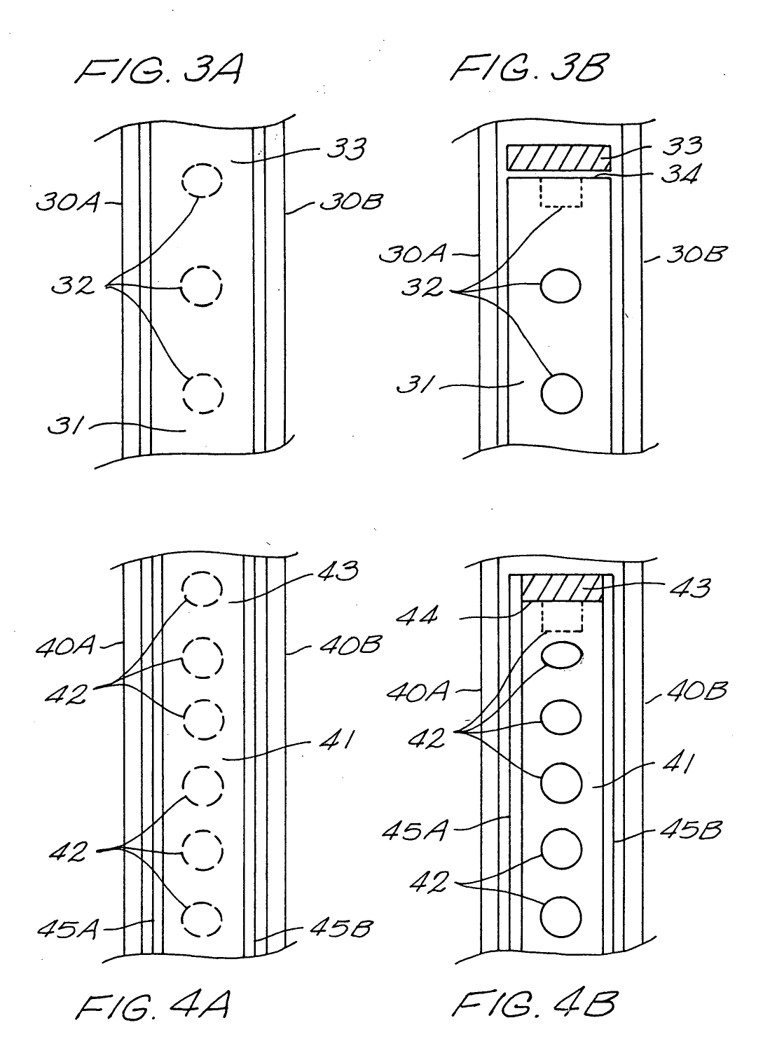

FIGS. 4A and 4B illustrate the preferred embodiment of the invention's nesting attribute of the belt to the rotating seed wheel. FIG. 4A illustrates a frontal view; FIG. 4B is a top/side view of the rotating seed wheel with the belt engaged thereto.

In this preferred embodiment, rotating seed wheel 41 is contained between side walls 40A and 40B. Cells 42, adapted to contain a seed (not shown), are spaced into rotating seed wheel 41. Rotating seed wheel 41 includes ridges 45A and 45B which are used to nest belt 43 against the peripheral surface 44 after the seed has been placed within cells 42. Belt 43 contacts the peripheral surface 44 and rides thereon. Lack of movement between peripheral surface 44 and belt 43 eliminates any abrasion the seed may experience with belt 44.

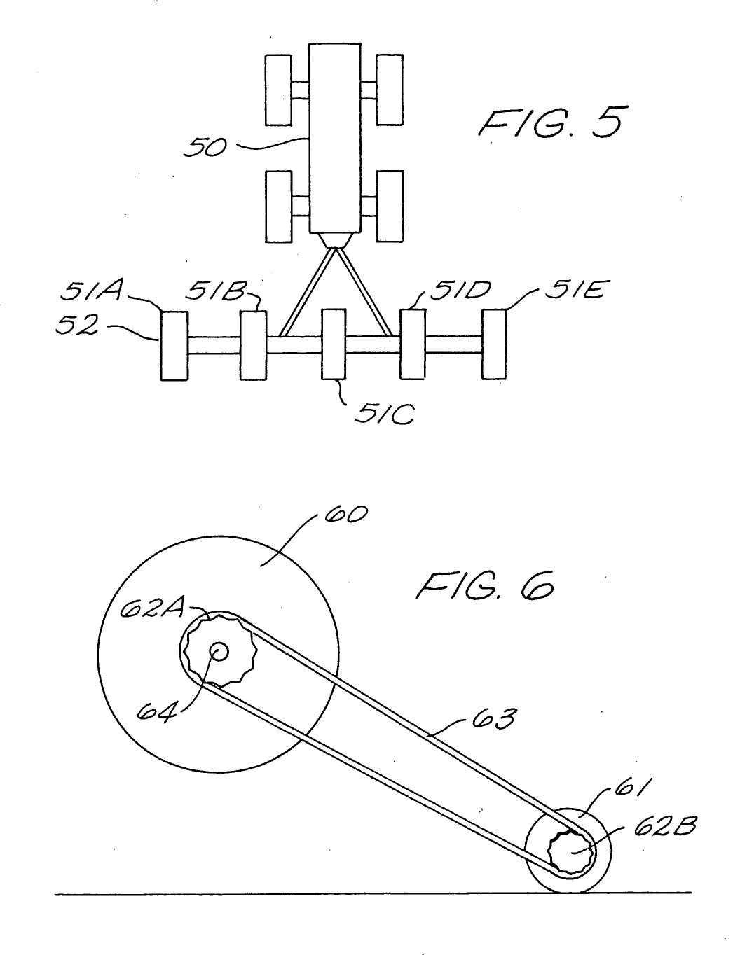

FIG. 5 illustrates a top view of the embodiment of the invention utilizing a gang of planters being pulled by an agricultural vehicle.

Agricultural vehicle 50 pulls a planting mechanism 52 through the agricultural field. Planting mechanism 52 contains a gang of planters 51A, 51B, 51C, 51D, and 51E as described above. In this embodiment, each of the planters operates independently of the other planters.

Although this illustration shows five planters (51A-51E), any number is possible depending on the application sought.

FIG. 6 illustrates a chain driven embodiment of the invention used to coordinate the rotation of the rotating seed wheel to traveling over the agricultural field.

While this embodiment of the invention utilizes a chain drive mechanism, those of ordinary skill in the art readily recognize that a variety of other techniques are useable in this context, including, but not limited to belt driven mechanism.

Rotating seed wheel 60 has an axle 64 extending therethrough with gear 62A affixed thereto. Ground engaging wheel 61 includes gear 62B. Chain 63 provides rotational force against gear 62A (and then by extension, rotating seed wheel 60) so that movement of rotating seed wheel 60 only occurs when ground engaging wheel 61 contacts the ground and is moving relative thereto.

The present invention provides a more efficient seed planting mechanism allowing the faster and more controlled application of seeds.

What is claimed is:

1. A seed planter mechanism comprising:
a) a hopper containing seeds therein;
b) a rotating seed wheel having cells therein, each of said cells recessed below a peripheral surface of said rotating seed wheel and configured to accept a single seed from the hopper as said seed wheel rotates through a bottom of the hopper; and,
c) a belt moving at a speed substantially equal to a speed of the peripheral surface, said belt engaging the peripheral surface of said rotating seed wheel after said rotating seed wheel exits from the hopper and disengaging from the peripheral surface of said rotating seed wheel proximate to a lowermost position of said rotating seed wheel.

2. The seed planter mechanism according to claim 1, wherein the peripheral surface includes a first and second ridge adapted to nest the belt therebetween.

3. The seed planter mechanism according to claim 2, wherein a seed is flung from a cell when said cell is at a lower position during rotation of said rotating seed wheel.

4. The seed planter mechanism according to claim 3, wherein said seed is flung in an opposite direction from a direction of movement of said seed planter mechanism.

5. The seed planter mechanism according to claim 3, further including a drive mechanism:
a) wherein said rotating seed wheel includes an axle; and,
b) further including:
1) a ground engaging wheel, and,
2) a drive mechanism communicating a rotation of said ground engaging wheel to the axle of said rotating seed wheel such that a speed of the peripheral surface approximates a horizontal speed of said rotating seed wheel.

6. The seed planter mechanism according to claim 5, further including a leading and a following gauge wheel adapted to maintain a bottom of said rotating seed wheel at a desired distance from a ground surface.

7. The seed planter mechanism according to claim 6, wherein said following gauge wheel is adapted to press a flung seed lying on the ground surface below the ground surface.

8. The seed planter mechanism according to claim 3,
a) wherein said peripheral surface of said rotating seed wheel includes a clean out groove extending the entirety of the circumference of the peripheral surface of said rotating seed wheel through each of said cells; and,
b) further including a clean out blade riding in the clean out groove.

9. The seed planter mechanism according to claim 6, wherein said hopper includes sealing mechanism adapted to prevent seeds from escaping from the hopper except by the cells in the rotating seed wheel.

10. The seed planter mechanism according to claim 9, wherein said sealing mechanism includes a rotating wheel rotating opposite the direction a rotational direction of said rotating seed wheel.

11. A seed planter combination comprising:
a) a tractor-like mechanism adapted to pull an implement in an agricultural field; and,
b) a planter implement secured to the tractor-like mechanism and having,
1) a hopper containing seeds therein,
2) at least two rotating seed wheels, each of staid rotating seed wheels having cells therein, each of said cells recessed below a peripheral surface of said rotating seed wheel and configured to accept a single seed from the hopper as said seed wheel rotates through a bottom of the hopper,
3) at least two belts, each of said of said belts associated with one of said at least two rotating seed wheels and moving at a speed substantially equal to a speed of the peripheral surface of the associated rotating seed wheel, said belt engaging the peripheral surface of said associated rotating seed wheel after said associated rotating seed wheel exits from the hopper and disengaging from the peripheral surface of said associated rotating seed wheel proximate to a lowermost position of said associated rotating seed wheel, and,
4) a driver mechanism selectively engaged with said at least two rotating seed wheels such that, when engaged, said at feast two rotating seed wheels rotate as said tractor like mechanism moves over an agricultural field.

12. The seed planter combination according to claim 11, wherein each of said rotating seed wheels includes a first and second ridge on the peripheral surface adapted to nest the belt therebetween

13. The seed planter combination according to claim 12, wherein each of said rotating seed wheels is adapted to fling a seed from a cell in a direction opposite a direction of movement of the planter implement when said cell is at a lower position during rotation of the rotating seed wheel.

14. The seed planter combination according to claim 13, wherein.
a) each of the planter implement wherein each of the at least two rotating seed wheels further includes a leading and a following gauge wheel adapted to maintain a bottom of an associated rotating seed wheel at a desired distance from a ground surface; and,
b) wherein said following gauge wheel is adapted to press a flung seed lying on the ground surface below the ground surface.

15. The seed planter combination according to claim 14,
a) wherein said peripheral surface of each of said rotating seed wheel includes a clean out groove extending the entirety of the circumference of the peripheral surface of said rotating seed wheel between the first and second ridge and through each of said cells; and,
b) further including a clean out blade riding in the clean out groove.

16. A seed planter component comprising:
a) a vertically oriented rotating seed wheel having cells therein, each of said cells recessed below a peripheral surface of said rotating seed wheel and configured to accept a single seed; and,
b) a belt moving at a speed substantially equal to a speed of the peripheral surface, said belt engaging the peripheral surface of said rotating seed wheel during a downward movement of the peripheral surface and disengaging from the peripheral surface of said rotating seed wheel proximate to a horizontal movement of the peripheral surface.

17. The seed planter component according to claim 16, wherein the peripheral surface includes a first and second ridge adapted to nest the belt therebetween.

18. The seed planter component according to claim 17, wherein each of said cells is configured to fling a seed from the cell when said cell is proximate to a lowermost position during rotation of said rotating seed wheel.

19. The seed planter component according to claim 18, wherein the peripheral surface of the rotating seed wheel includes a clean out groove extending the entirety of the circumference of the peripheral surface of said rotating seed wheel through each of said cells and between the first and second ridge.
